(19) United States
(12) Patent Application Publication
(10) Pub. No.: US 2026/0276369 A1
(43) Pub. Date: Sep. 17, 2026

(54) PROCESSING APPARATUS, OPTICAL SYSTEM, OPTICAL MEASUREMENT METHOD, AND NON-TRANSITORY STORAGE MEDIUM STORING OPTICAL MEASUREMENT PROGRAM

(71) Applicant: KABUSHIKI KAISHA TOSHIBA, Kawasaki-shi (JP)

(72) Inventors: Hiroshi OHNO, Tokyo (JP); Rina NAGANO, Yokohama Kanagawa (JP); Takahiro KAMIKAWA, Yokohama Kanagawa (JP)

(73) Assignee: KABUSHIKI KAISHA TOSHIBA, Kawasaki-shi (JP)

(21) Appl. No.: 19/551,734

(22) Filed: Feb. 27, 2026

(30) Foreign Application Priority Data
Mar. 17, 2025 (JP) 2025-042792

(51) Int. Cl. G01B 11/24; G06T 7/579

(52) U.S. Cl. CPC G01B 11/24; G06T 7/579; G06T 2207/10016; G06T 2207/10028

(57) ABSTRACT

According to an embodiment, a processing apparatus to be used for optical measurement includes a processor. The processor is configured: to acquire an image of an object on an optical axis of an image capture by optical imaging using a light selection portion that selectively allows a plurality of wavelengths different from each other from a surface of the object to pass through, and to acquire depth information on the object with respect to the image capture based on variance of pixel values of the image or variance of pixel value change indexes.

### CROSS-REFERENCE TO RELATED APPLICATIONS

This application is based upon and claims the benefit of priority from Japanese Patent Application No. 2025-042792, filed Mar. 17, 2025, the entire contents of all of which are incorporated herein by reference.

### FIELD

Embodiments described herein relate generally to a processing apparatus, an optical system, an optical measurement method, and a non-transitory storage medium storing an optical measurement program.

### BACKGROUND

In various industries, non-contact three-dimensional measurement of objects becomes important. There is a method of acquiring z-axis (depth) information by using a general camera, capturing a plurality of images of an object while moving the object in the optical axis direction (z axis direction; depth direction) to check whether the images are in focus. This method is also called a depth from focus (DFF) method.

### BRIEF DESCRIPTION OF THE DRAWINGS

FIG. 1 is a schematic diagram showing an optical system according to a first embodiment and a second embodiment.

FIG. 2 is a flowchart showing processing of the optical system according to the first embodiment and the second embodiment.

FIG. 3 is an example of an image of an object captured using the optical system according to the first embodiment.

FIG. 4 is an example of an image of the same object as in FIG. 3 captured from the same position and the same viewpoint using a normal camera.

FIG. 5A shows examples of images of a certain range of a surface of a plastic plate as an object captured using the optical system according to the present embodiment, while z-scanning the plastic plate in a range from z=0.0 mm to z=6.0 mm with a step width of 0.5 mm along the optical axis.

FIG. 5B shows a contrast calculated using the examples of the images shown in FIG. 5A, which is plotted along the z position.

FIG. 6A shows example of images of a certain range of a surface of a plastic plate as an object captured using an image capture excluding a light selection portion of the optical system according to the present embodiment, while z-scanning the plastic plate in a range from z=0.0 mm to z=6.0 mm with a step width of 0.5 mm along the optical axis.

FIG. 6B shows a contrast calculated using the example of the images shown in FIG. 6A, which is plotted along the z position.

FIG. 7 is a schematic diagram showing another example of a light selection portion of an optical apparatus of the optical system according to the first embodiment.

FIG. 8 is a schematic diagram of an illumination portion that is used in the optical system according to the first embodiment.

FIG. 9 is a schematic diagram of a first light selection portion of the optical system according to a third modification of the first embodiment.

FIG. 10 is a schematic diagram of a second light selection portion of the optical system according to the third modification of the first embodiment.

FIG. 11 is a schematic diagram showing that an image capture supported by a delta-type parallel link that is used in an optical system according to the second embodiment is brought close to an object placed on a pedestal.

FIG. 12 is a schematic diagram showing that the image capture supported by the delta-type parallel link that is used in the optical system according to the second embodiment is separated away from the object compared to the position shown in FIG. 11, and retracted from above the object.

### DETAILED DESCRIPTION

Hereinafter, each embodiment will be described with reference to the drawings. The drawings are schematic or conceptual, and a relationship between a thickness and a width of each part, a size ratio between parts, and the like are not necessarily the same as actual ones. In addition, even in a case of representing the same part, dimensions and ratios may be represented differently from each other depending on the drawings. In the present specification and each drawing, elements similar to those previously described in connection with preceding drawings are denoted by the same reference signs, and their detailed descriptions are appropriately omitted.

In the present specification, light is a type of electromagnetic wave, and includes a gamma ray, X-ray, ultraviolet ray, visible light, infrared ray, radio wave, and the like. In the present embodiment, it is assumed that light is visible light and has a wavelength in the range of 400 nm to 750 nm, for example.

An object of the present embodiment is to provide a processing apparatus, an optical system, an optical measurement method, and a non-transitory storage medium storing an optical measurement program that can acquire depth information even for an object having little texture.

According to the embodiment, a processing apparatus to be used for optical measurement includes a processor. The processor is configured: to acquire an image of an object on an optical axis of an image capture by optical imaging using a light selection portion that selectively allows a plurality of wavelengths different from each other from a surface of the object to pass through, and to acquire depth information on the object with respect to the image capture based on variance of pixel values of the image or variance of pixel value change indexes.

### First Embodiment

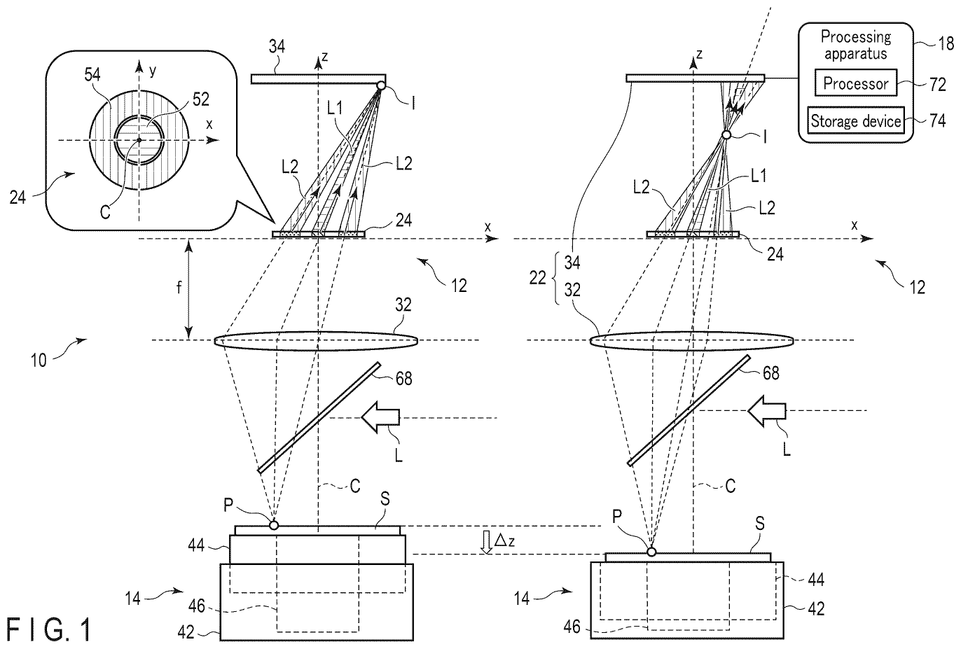

Hereinafter, an optical system 10 according to a first embodiment will be described with reference to FIGS. 1 to 7.

The left and right diagrams in FIG. 1 show schematic cross-sectional views according to the present embodiment. The optical system 10 according to the present embodiment includes an optical apparatus 12, a scanner 14, and a processing apparatus (controller) 18 that controls the optical apparatus 12 and the scanner 14.

The optical apparatus 12 includes an image capture (image capturing portions) 22 and a light selection portion 24.

The image capture 22 can acquire an image of an object S illuminated with appropriate illumination light L. The image capture 22 is assumed to include an image-forming optical element 32 and an image sensor 34.

The image-forming optical element 32 collects (condenses) a group of light beams emitted from an object point P on a surface of the object S at an imaging point I. The image-forming optical element 32 can form an image of light. The image-forming optical element 32 may be, for example, a single lens, lens assembly formed by a plurality of lenses, concave mirror, Fresnel lens, Fresnel zone plate, diffraction grating, gradient index lens (GRIN lens), or the like. That is, the image-forming optical element 32 may be any element as long as it can form an image of light. A surface on which an image of a set of points at infinity is formed by the image-forming optical element 32 is defined as a focal plane. The focal plane and its vicinity are referred to as a focal plane region. An optical axis C of the image-forming optical element 32, which is an optical axis of the image capture 22, is a straight line orthogonal to the focal plane. It is assumed that light emitted from a sufficiently distant point on the optical axis C is imaged at a point where the optical axis C intersects with the focal plane. This point is referred to as a focal point.

The image-forming optical element 32 has a principal surface that is geometrically and optically determined. A distance defined by the focal plane of the image-forming optical element 32 and the principal surface closest thereto is defined as a focal length f of the image-forming optical element 32.

The image-forming optical element 32 according to the present embodiment is assumed to be a lens assembly formed by a plurality of lenses. Here, this is referred to as an image forming lens. However, in FIG. 1, the image forming lens, which is a lens assembly, is schematically drawn as a lens, for the sake of simplicity. In addition, the image-forming optical element 32 is not limited thereto, and may be any element as long as it forms an image of light. In the cross-sectional view of the optical apparatus 12 shown in FIG. 1, it is assumed that the optical axis C of the image-forming optical element 32 is included in this cross section. The image-forming optical element 32 included in the image capture 22 can be referred to as an image-capturing image-forming optical element. In addition, the optical axis C of the image-capturing image-forming optical element 32 can be referred to as an image-capturing optical axis.

The image sensor 34 may be a line sensor or an area sensor. That is, the image sensor 34 may be any sensor as long as it has a pixel that receives light and converts the light into a signal. In addition, the image sensor 34 may be a sensor that can acquire an independent signal according to the characteristic of light. The image sensor 34 may be, for example, a color image sensor that acquires a substantially independent signal according to the wavelength spectrum.

In the present embodiment, the image sensor 34 can identify (spectrally disperse) and receive light of a first wavelength and light of a second wavelength different from the first wavelength, and can acquire them as independent signals.

The light selection portion 24 is arranged on the optical axis C. The light selection portion 24 is arranged at or near the focal plane of the image-forming optical element 32. The light selection portion 24 has two different selection regions of a first light selection region 52 and a second light selection region 54.

The first light selection region 52 transmits light incident thereon by changing (varying) the characteristic of the light or transmits the light without changing (varying) the characteristic. Here, optical characteristics are a direction, wavelength, wavelength spectrum, polarized light, brightness, illuminance, and light flux (light amount) of an incident light beam. The second light selection region 54 transmits light incident thereon by changing (varying) the characteristic of the light or transmits the light without changing (varying) the characteristic.

However, if light having the same characteristic is incident on the first light selection region 52 and the second light selection region 54, the characteristic of the light having passed through the first light selection region 52 is different from that of the light having passed through the second light selection region 54. It is assumed that the light having passed through the light selection portion 24 can be identified based on its characteristic of the light having passed through either the first light selection region 52 or the second light selection region 54, by the image sensor 34 receiving the light.

In the present embodiment, it is assumed that the first light selection region 52 is configured to transmit light of the first wavelength and is not configured to transmit light of the second wavelength. Here, light of the second wavelength is blocked from passing through by being shielded or reflected by the first light selection region 54. The optical axis C of the image-forming optical element 32 intersects with the first light selection region 52. On the other hand, the optical axis C does not intersect with the second light selection region 54. Therefore, the light selection portion 24 includes the first light selection region 52 including the optical axis C of the image-forming optical element 32 of the image capture 22 and the second light selection region 54 not including the optical axis C. It is assumed that the second light selection region 54 is configured to transmit light of the second wavelength and is not configured to transmit light of the first wavelength.

It is assumed that light of the first wavelength is, for example, blue light of a wavelength of 450 nm. In addition, it is assumed that light of the second wavelength is, for example, red light of a wavelength of 650 nm.

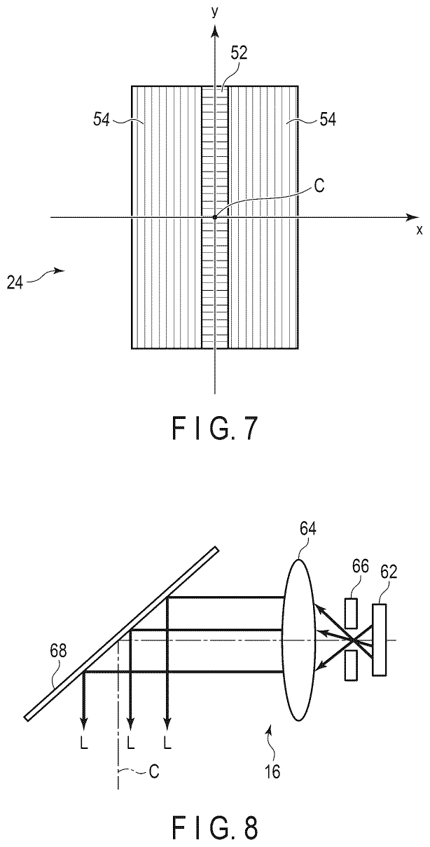

In the present embodiment, the light selection portion 24 is a concentric circle with the first light selection region 52 on the inner side and the second light selection region 54 on the outer side, but is not limited thereto. The light selection portion 24 may have, for example, a substantially rectangular band shape, a stripe shape (see FIG. 7) in which the first light selection region 52 and the second light selection region 54 are arranged in order in, for example, the x-axis direction, a polygonal shape, or any shape. In FIG. 1, an example in which the center of the first light selection region 52 coincides with the optical axis C is described, but the center of the first light selection region 52 may be shifted from the optical axis C.

The object S may transmit or reflect light. Alternatively, the object S may be translucent. A point on the surface of the object S or inside the object S is referred to as an object point. Hereinafter, unless otherwise specified, it is assumed that the object S reflects light, and the object point is on the surface of the object S. The surface of the object S can be referred to as an object surface or an object plane.

The scanner 14 is, for example, a device that can move the object S relatively closer to and farther away from the image capture 22. The scanner 14 includes, for example, a pedestal 42, an operation stage (Z stage) 44 that is movable in the optical axis C (z axis) direction with respect to the pedestal 42, and an actuator 46 that moves the operation stage 44 in the z axis direction, which is a direction along the optical axis C. It is preferable that a linear stepping motor is used as the actuator 46, for example, and the position, moving direction, and moving speed of the operation stage 44 are controlled by the processing apparatus 18 controlling the actuator 46.

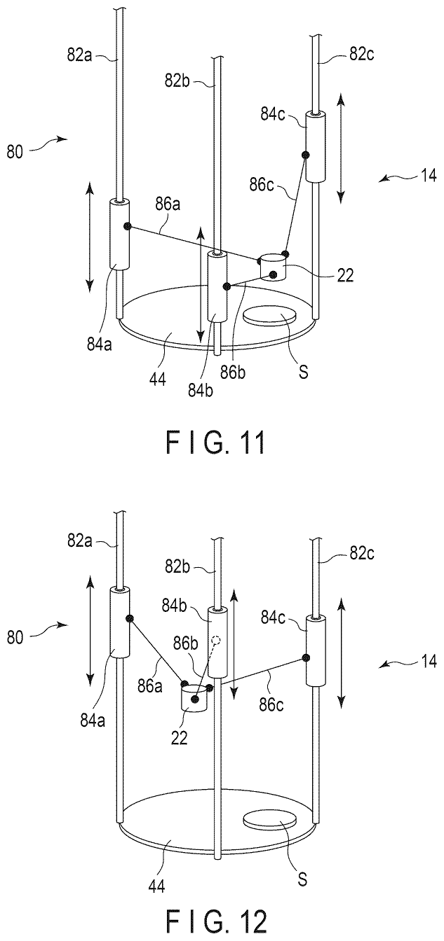

In the present embodiment, it is assumed that the scanner 14 moves the operation stage 44 with respect to the pedestal 42 to move the object S. However, the scanner 14 is not limited thereto, and may be capable of moving the image capture 22 in the direction along the optical axis C as described later (see FIGS. 11 and 12). The scanner 14 may also be movable in a direction orthogonal to the optical axis C. That is, the scanner 14 may be any unit as long as it changes the relative position between the image capture 22 and the object S along the optical axis C.

In the present embodiment, the illumination light L is white light including light of the first wavelength and light of the second wavelength. It is assumed that the illumination light L can be emitted to the object S along the optical axis C by a beam splitter 68 arranged between the image-forming optical element 32 of the image capture 22 and the operation stage 44. Such an irradiation method of the illumination light L is generally referred to as coaxial epi-illumination. The illumination light L is preferably parallel light or light closer to parallel light, but is not limited to parallel light.

In FIG. 1, the processing apparatus 18 is shown in the system 10 in the right diagram due to space constraints on the paper, but is naturally present in the system 10 in the left diagram. In the present embodiment, the processing apparatus 18 can control the image sensor 34 of the optical apparatus 12 and the actuator 46 of the scanner 14. The processing apparatus 18 can control the image sensor 34 in conjunction with the actuator 46 to acquire an image of the surface of the object S while moving the position of the object S closer to and/or farther away from the image capture 22. The processing apparatus 18 includes a processor 72 that holds the image captured by the image capture 22 and performs image processing, which will be described later, and a storage device 74 that saves the image.

The processor 72 is, for example, a CPU or a GPU, but may be any element as long as it can perform image processing, which will be described later. The processor 72 corresponds to a central part of a computer that performs processing, such as calculation and control necessary for processing of the processing apparatus 18, and integrally controls the entire processing apparatus 18. The processor 72 performs control to implement various functions of the processing apparatus 18 based on a program such as system software, application software, or firmware stored in the storage device (non-transitory storage medium) 74 such as a ROM or an auxiliary storage device. The processor 72 includes, for example, a central processing unit (CPU), a micro processing unit (MPU), a digital signal processor (DSP), an application specific integrated circuit (ASIC), a field programmable gate array (FPGA), a graphics processing unit (GPU), or the like. Alternatively, the processor 72 is a combination of a plurality of these. The number of processors 72 provided in the processing apparatus 18 may be one or plural.

The processing apparatus 18 performs various functions by causing the processor 72 to execute a program or the like stored in the storage device (non-transitory storage medium) 74. Note that a control program for the processing apparatus 18 is not stored in the storage device (non-transitory storage medium) 74 of the processing apparatus 18, and is preferably provided on an appropriate server or cloud. In this case, the control program is executed while communicating with, for example, the processor 72 of the optical system 10 through a communication interface. That is, the processing apparatus 18 may be included in the optical system 10, or may be on a server or cloud for various inspection site systems, which are away from the optical system 10. For this reason, it is also preferable that an optical inspection program is not stored in the storage device 74 but is on a server or cloud, and the program is executed while communicating with, for example, the processor 72 of the optical system 10 through a communication interface. Therefore, the processor 72 (processing apparatus 18) can execute an optical measurement program (optical measurement algorithm), which will be described later. The location of the server may be domestic or foreign.

The processor 72 (processing apparatus 18) can control the position, moving direction, and moving speed of the operation stage 44 through the operation of the actuator 46, the acquisition timing of image data by the image sensor 34, the acquisition of image data from the image sensor 34, and the like, and can also perform appropriate image processing on a certain image. The image processing here, which will be described later, includes acquiring an image, outputting a pixel value, acquiring a distance (depth) between the image capture 22 and the object S based on the variance of the pixel values or the variance of the pixel value change indexes using a DFF method or a depth from defocus (DFD) method, outputting a three-dimensional shape based on the acquired distance (depth) between the image capture 22 and the object S, or the like.

In addition, the storage device 74 is, for example, an HDD or an SSD, but may be any device as long as it can store (save) images, for example.

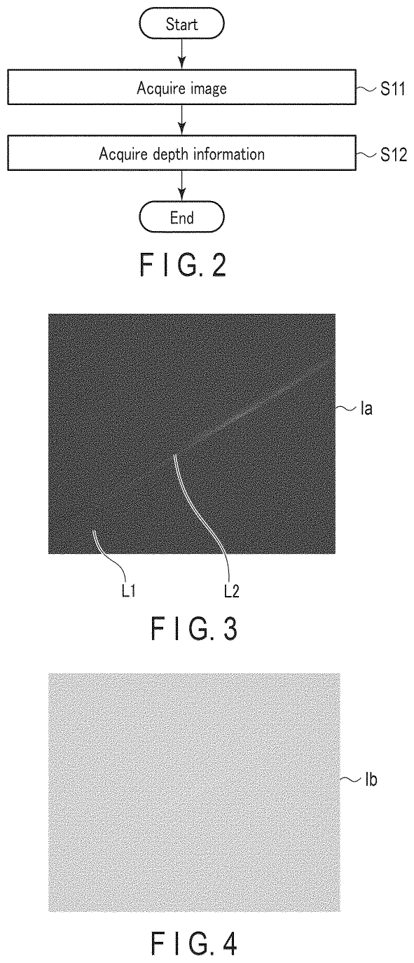

Next, the operation of the processing apparatus 18 of the optical system 10 according to the present embodiment will be described using a procedure shown in FIG. 2.

First, an image of the object S is acquired (step S11). In the present embodiment, an example will be described in which the operation stage 44 moves the object S closer to or farther away from the image capture 22 and the light selection portion 24 in a predetermined range. However, the image capture 22 and the light selection portion 24 may move closer to and farther away from the object S in a predetermined range. In addition, both the object S, and the image capture 22 and the light selection portion 24 may move, and the object S, and the image capture 22 and the light selection portion 24 may relatively move closer to and farther away from each other.

The illumination light L is emitted to the object S along the optical axis C of the image-forming optical element 32 through the beam splitter 68.

In a case where the object plane of the object S is smooth and orthogonal to the optical axis C, the illumination light L is reflected along the optical axis C. The reflected light from the object plane of the object S is incident on the light selection portion 24 through the beam splitter 68 and the image-forming optical element 32. The light selection portion 24 is arranged on the focal plane (or also referred to as a Fourier plane) of the image-forming optical element 32. Therefore, a first light beam L1 of white light incident on the object plane of the object S along the optical axis C and reflected along the optical axis C reaches the first light selection region 52 on the optical axis C. Then, the first light selection region 52 transmits light of the first wavelength and does not transmit light of the second wavelength. Therefore, the first light beam L1 is changed to blue light (first wavelength) by the light selection portion 24, and is received by the image sensor 34.

On the other hand, in a case where minute irregularities are on the object plane of the object S, the reflected light (white light) of the illumination light L travels while being inclined in various directions with respect to the optical axis C. That is, the illumination light L is scattered by the minute irregularities on the object plane and changed to scattered light. In a case where the object S is reflective, the scattering angle distribution can be expressed by the bidirectional reflectance direction function (BRDF). Therefore, if the information on the BRDF is obtained, the information on the minute irregularities on the object plane can be obtained. For example, since the reflection of light on a flat object plane is specular reflection, the scattering angle distribution is narrow. On the other hand, if minute irregularities are on an object plane, the scattering angle distribution is generally wide. Therefore, a second light beam L2 reflected in a direction inclined with respect to the optical axis C reaches the second light selection region 54, which is located outside the first light selection region 52 in the focal plane of the image-forming optical element 32. Then, the second light selection region 54 transmits light of the second wavelength and does not transmit light of the first wavelength. Therefore, the second light beam is changed to red light (second wavelength) by the light selection portion 24, and is received by the image sensor 34.

As described above, by arranging the light selection portion 24 on the focal plane of the image-forming optical element 32, light from the object point P of the object S is changed to reflected light according to the properties of the object plane on the image sensor 34, which allows for coloring according to the direction of a light beam in the image sensor 34.

In the present embodiment, the image sensor 34 can identify (spectrally disperse) and receive light of the first wavelength and light of the second wavelength, and can independently output the pixel value for the first wavelength and the pixel value for the second wavelength in each pixel. For example, it is assumed that the object S is white plastic and has a smooth surface. Then, it is assumed that minute scratches and irregularities are on the smooth surface. In a case where an image of the object plane is captured using the optical system 10 according to the present embodiment, as in an image Ia shown in FIG. 3, in each pixel, the first light beam L1 reflected from the smooth surface is blue, and the second light beam L2 reflected from the minute scratches and irregularities is red. As described above, the image Ia is colored depending on the presence or absence of minute scratches or irregularities. Here, the minute scratches and irregularities can be regarded as the texture of the object surface. On the other hand, as in an image Ib shown in FIG. 4, the texture cannot be confirmed in the image captured by a normal camera that does not include the light selection portion 24. That is, the texture of the surface of the object S can be made clear by using the optical system 10 according to the present embodiment.

In FIG. 1, the processing apparatus 18 (processor 72) acquires a plurality of images (see FIG. 3) while moving the object S along the optical axis C by the actuator 46 moving the operation stage 44 on which the object S is placed. For this reason, the processing apparatus 18 acquires a plurality of images Ia while relatively moving the image capture 22 and the object S along the optical axis C of the image capture 22. At this time, the operation stage 44 may be moved in the order from the left diagram to the right diagram in FIG. 1, or the operation stage 44 may be moved in the order from the right diagram to the left diagram in FIG. 1.

If the surface of the object S has a texture, the depth can be acquired (calculated) based on the variance of the pixel values of the images acquired using the depth from focus (DFF) method or the like, for example (step S12). As will be described later, if the depth can be acquired, the processing apparatus 18 can acquire the three-dimensional shape of the object S.

For example, the processing apparatus 18 determines the texture of the surface of the object S captured in a certain image captured using the optical apparatus 12 according to the present embodiment, based on the pixel value change index of the second light beam L2 in each pixel. Here, the pixel value change index may be the pixel value itself, the first derivative of the pixel value with respect to the pixel position, or the second derivative of the pixel value with respect to the pixel position. That is, the pixel value change index may be any amount as long as it is correlated with pixel value changes. In the present embodiment, the pixel value itself is used as the pixel value change index.

The processing apparatus 18 calculates the depth based on the variance of the pixel values (the pixel value change indexes). In the present embodiment, light of the first wavelength and light of the second wavelength can be identified (spectrally dispersed) and received, and the light of the first wavelength and the light of the second wavelength are respectively converted into independent signals, which means that an image Ia acquired simultaneously is decomposed into the image of the first wavelength and the image of the second wavelength, that is, two images are substantially acquired. By comparing the focusing degrees indicating the focus accuracy between the pixels of the image of the first wavelength, the depth of the object plane of the object S with respect to the image capture 22, that is, the distance is calculated. Similarly, by comparing the focusing degrees indicating the focus accuracy between the pixels of the image of the second wavelength, the depth of the object plane of the object S with respect to the image capture 22, that is, the distance is calculated. As described above, it is preferable to calculate the depth based on each of the variance of the pixel values for the first wavelength and the variance of the pixel values for the second wavelength. Note that an image is recognized as having low contrast if the variance of the pixel values is small, and an image is recognized as having high contrast if the variance of the pixel values is large. In the example of the image Ia shown in FIG. 2, the variance of the pixel values for the first wavelength can be smaller than the variance of the pixel values for the second wavelength, and the contrast of the image based on the first wavelength can be lower than the contrast of the image based on the second wavelength.

Here, in the case of the present embodiment, the first light beam L1 intersects with the optical axis C at the position of the focal point f of the image-forming optical element 32, and the second light beam L2 does not intersect with the optical axis C at the position of the focal point f of the image-forming optical element 32. In addition, in the light selection portion 24, the first light beam L1 passes through the center position of the disk-shaped first light selection region 52 or in the vicinity thereof. For this reason, the first light beam L1 passing through the light selection portion 24 is received by the image sensor 34 as a relatively thin light beam. Therefore, the ratio of the areas of the first light selection region 52 and the second light selection region 54 of the light selection portion 24 may be set such that the first light selection region 52 is relatively narrower than that shown in FIG. 1.

The second light beam L2 passes through the annular second light selection region 54, which is located outside the disk-shaped first light selection region 52. At this time, since reflected light is spread due to the scattering of light, the second light beam L2 passing through the light selection portion 24 is directed to the image sensor 34 as a light beam with a larger width than that of the first light beam L1. Therefore, the image based on the second wavelength obtained by appropriately moving the scanner 14 is more likely to be blurred than the image based on the first wavelength.

For example, in the left diagram in FIG. 1, it is assumed that the focus is on the image sensor 34. When the object S in the left diagram of FIG. 1 is moved away from the image capture 22 by Δz as shown in the right diagram in FIG. 1 by the operation stage 44, the imaging point with respect to the object plane of the same object S is shifted to the object S side according to the performance of the image-forming optical element 32. At this time, the image of the second light beam L2 of the second wavelength is more remarkably blurred than the image of the first light beam L1 of the first wavelength. For this reason, if the DFF method is applied using the image based on the second wavelength rather than the image based on the first wavelength, the contrast between, for example, the focused image and the out-of-focus image can be increased, and the imaging position (z position), that is, depth information on the object S can be acquired more accurately.

Since the texture is unclear in an image captured by a normal camera (see FIG. 4), the focal position (the position in the depth direction in focus) cannot be identified with such an image even if the DFF method is used.

In the example of the image Ia (see FIG. 3) acquired using the optical apparatus 12 according to the present embodiment, a clear texture can be obtained even for the object S, which has little texture in the image Ib (see FIG. 4) captured by a normal camera. This is because the surface scattering characteristics are changed due to the surface irregularities of the texture, and are captured as greater intensity changes based on light of the first wavelength and light of the second wavelength, compared to a conventional camera. Using images acquired using the optical system 10 according to the present embodiment can make the texture clear, which has an effect that the focal position can be identified using, for example, the DFF method. For this reason, according to the present embodiment, it is possible to acquire the depth information even for the object S having little texture using a distance acquisition (estimation) algorithm such as the DFF method.

By using an image captured at a specific working distance (distance between the object S and the image capture 22) without using the scanner 14 in the processing apparatus 18 according to the present embodiment, it is possible to estimate the working distance to some extent based on the variance of the pixel values. For example, if the acquired image is in focus, the working distance can be calculated from the optical performance of the image-forming optical element 32 and the distance between the image-forming optical element 32 and the image sensor 34. That is, it is not always necessary to acquire a plurality of images in, for example, the DFF method, and it is possible to estimate depth (distance) information based on the variance of the pixel values (pixel value change indexes) of an image, that is, the variance of the pixel values for the first wavelength and the variance of the pixel values for the second wavelength included in the information on the image.

If an object surface has minute irregularities, the angular distribution of scattered light that can be expressed by the BRDF is wider compared to a smooth surface. Therefore, the amount of light that passes through the second light selection region 54 of the light selection portion 24 increases. That is, the minute irregularities are imaged based on red light (second wavelength). Since the minute irregularities can be regarded as the texture of the object surface, the texture can be made clearer using the image based on red-light receiving signals than blue-light receiving signals (first wavelength). That is, using the variance of an image that has received red light has an effect that the depth information can be more accurately identified by applying the DFF method.

Note that the processing apparatus 18 can identify the three-dimensional shape of the object S by acquiring the depth information for each pixel corresponding to each object point in the image acquired by the image sensor 34.

In the present embodiment, an example has been described in which the DFF method is used as a method for acquiring z-axis (depth) information. As the method of acquiring z-axis (depth) information, the depth information may be acquired using the DFD method in addition to the DFF method, for example.

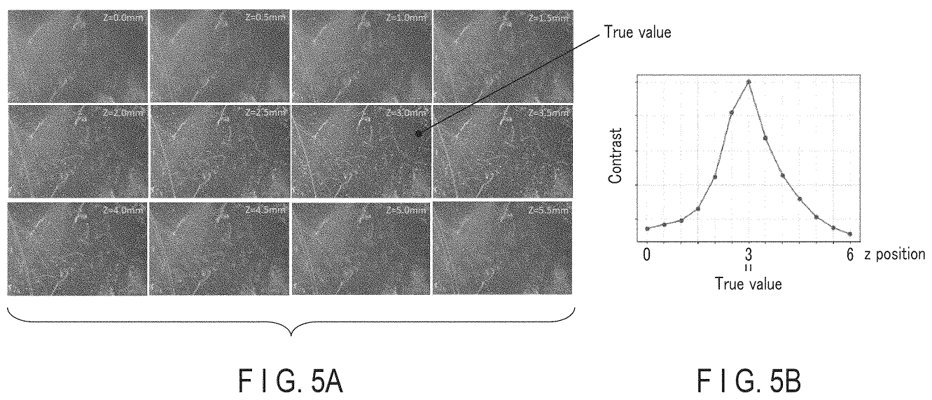

FIG. 5A shows, side by side, images of a certain range of a surface of a plastic plate as a certain object S, which is placed on the operation stage 44 of the scanner 14, captured using the optical system 10 according to the present embodiment, while z-scanning the object S by moving the operation stage 44 in a range from z=0.0 mm to z=6.0 mm with a step width of 0.5 mm along the optical axis C. Note that the object S in the images shown in FIG. 5A is a plastic plate. Note that z=0.0 mm was set appropriately, and the position of the operation stage 44 in the z-axis direction was set such that a true value was in focus at z=3.0 mm between z=0.0 mm and z=6.0 mm.

FIG. 5B shows the contrast calculated from the images shown in FIG. 5A plotted along the z position. It is assumed that an image with the maximum contrast is defined as a focused image. Note that, here, each of the obtained images (see FIG. 5A) was converted into grayscale, the variance of all the pixels of the grayscale image was calculated to search for an image with the largest variance.

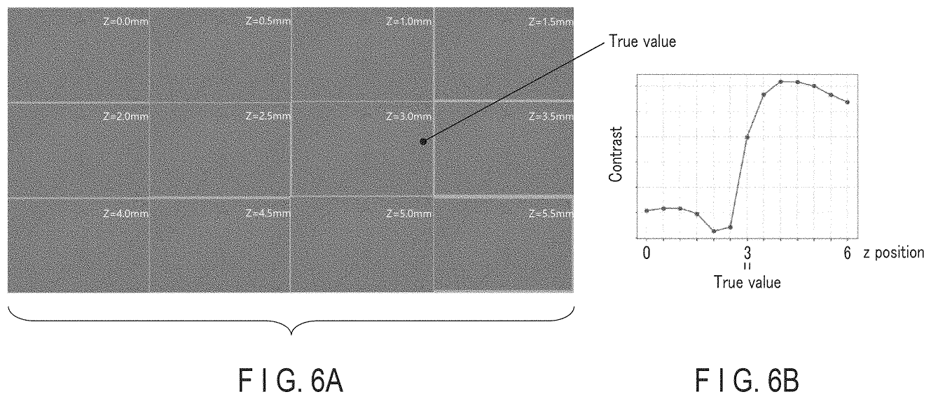

In addition, FIG. 6A shows, side by side, images of the same surface position of the same plastic plate (object) S as in FIG. 5A captured using a normal camera, instead of the image capture 22 and the light selection portion 24 of the optical system 10 according to the present embodiment, while z-scanning the object S by moving the operation stage 44 in a range of z=0.0 mm to z=6.0 mm with a step width of 0.5 mm along the optical axis C. Note that the normal camera here is the image capture 22 excluding the light selection portion 24 of the optical system 10 according to the present embodiment with respect to a certain range of a surface of a certain object S. FIG. 6B shows the contrast calculated from the images shown in FIG. 6A plotted along the z position.

In the images shown in FIG. 5A, it can be seen that the images are obviously blurred when deviating from the focal position (true value (z=3.0 mm)) as compared with the image at the focal position. As shown in FIG. 5B, it can be seen that the optical apparatus 12 including the image capture 22 and the light selection portion 24 according to the present embodiment has a contrast peak at the true value (z=3.0 mm). Therefore, it has been confirmed that the depth information can be identified more accurately by using the optical system 10 according to the present embodiment.

On the other hand, it can be seen that the peak (z=4.0 mm) of the contrast (see FIG. 6B) obtained using the normal camera deviates from the true value (z=3.0 mm).

Note that, here, an example has been described in which an image with the maximum contrast is recognized as a focused image. For example, a focused image may be recognized by detecting the edge of the image using a Sobel filter or the like, and using the sharpness index of the image after applying the filter as the pixel value change index.

In the present embodiment, blue light is used as the first wavelength, and red light is used as the second wavelength. It is assumed that the first light selection region 52 of the light selection portion 24 transmits light of the first wavelength and does not transmit light of the second wavelength. It is assumed that the second light selection region 54 of the light selection portion 24 transmits light of the second wavelength and does not transmit light of the first wavelength. It is assumed that the second light selection region 54 of the light selection portion 24 transmits light of the second wavelength and does not transmit light of the first wavelength.

Red light may be used as the first wavelength, and blue light may be used as the second wavelength. In this case, it suffices that the first light selection region 52 on the center side of the light selection portion 24 transmits light of the first wavelength and does not transmit light of the second wavelength and that the annular second light selection region 54 of the light selection portion 24 transmits light of the second wavelength and does not transmit light of the first wavelength.

According to the present embodiment, the processing apparatus 18 to be used for optical measurement includes the processor 72 that acquires, by the image capture 22, the image Ia of the object S on the optical axis C of the image capture 22 by optical imaging using the light selection portion 24 that selectively allows a plurality of wavelengths different from each other from the surface of the object S to pass through, and acquires the depth information on the object S with respect to the image capture 22 based on the variance of the pixel values of the image Ia or the variance of the pixel value change indexes. In addition, the optical measurement method includes acquiring, by the image capture 22, the image Ia of the object S by optical imaging using the light selection portion 24 that selectively allows a plurality of wavelengths different from each other from the surface of the object S to pass through, and acquiring the depth information on the object S with respect to the image capture 22 based on the variance of the pixel values of the image Ia or the variance of the pixel value change indexes. In addition, the optical measurement program causes a computer (the processing apparatus 18 or the processor 72) to execute acquiring, by the image capture 22, the image Ia of the object S by optical imaging using the light selection portion 24 that selectively allows a plurality of wavelengths different from each other from the surface of the object S to pass through, and acquiring the depth information on the object S with respect to the image capture 22 based on the variance of the pixel values of the image Ia or variance of the pixel value change indexes.

According to the present embodiment, it is possible to provide the processing apparatus 18, the optical system 10 including such the processing apparatus 18, the optical measurement method, and the non-transitory storage medium storing the optical measurement program that can acquire the depth information even for the object (object plane) S having a texture or little texture.

According to the present embodiment, the processing apparatus 18 (processor 72) to be used for optical measurement acquires a plurality of images by the image capture 22 while relatively moving the image capture 22 and the object S along the optical axis C of the image capture 22. For this reason, the processing apparatus 18 can acquire more detailed depth information between the image capture 22 and the object S using the DFF method or the like.

In the example shown in FIG. 1, an example has been described in which the light selection portion 24 has a concentric circle with the first light selection region 52 on the inner side and the second light selection region 54 on the outer side. As shown in FIG. 7, in a case where the light selection portion 24 has a stripe shape, the widths of the first light selection region 52 and the second light selection region 54 along the x-axis direction may be the same, or the width of the second light selection region 54 may be wider than that of the first light selection region 52.

According to the present embodiment, the processing apparatus 18, the optical system 10, the optical measurement method, and the non-transitory storage medium storing the optical measurement program, which are configured to acquire the depth information even for the object S having little texture, are provided. In addition, the processing apparatus 18, the optical system 10, the optical measurement method, and the optical measurement program can identify the three-dimensional shape of the object S by acquiring the depth information for each object point.

### First Modification

A first modification of the present embodiment will be described with reference to FIG. 8.

In the present first modification, it is assumed that the optical apparatus 12 according to the present embodiment further includes an illumination portion 16. As shown in FIG. 8, the illumination portion 16 includes a light source 62, an illumination lens (second image-forming optical element) 64, a pinhole opening 66, and a beam splitter 68.

The light source 62 may be, for example, white light source or a white light-emitting diode (LED). However, the light source 62 is not limited thereto and may be anything as long as it emits light, and may be a laser diode (LD). Alternatively, the light source 62 may be sunlight, a plasma light source, thermal radiation light source (Incandescent light bulb, halogen lamp, xenon lamp, or the like), or anything.

The illumination lens 64 is, for example, an image forming lens. In FIG. 8, the illumination lens 64 is schematically represented as a lens, but may be a lens assembly formed by a plurality of lenses. Alternatively, the illumination lens 64 may be a concave mirror, a convex mirror, or a combination thereof. That is, the illumination lens 64 may be any optical element as long as it has a function of collecting a group of light beams emitted from a point of an object, that is, an object point, at a conjugate imaging point. The group of light beams emitted from the object point on the object surface by the illumination lens 64 is collected (condensed) at the imaging point, which is referred to as image formation. Alternatively, it is also referred to as the transfer of the object point to the imaging point (conjugate point of the object point). In addition, a collective surface of conjugate points to which a group of light beams emitted from a sufficiently far object point is transferred by the illumination lens 64 is referred to as a focal plane of the illumination lens (image-forming optical element) 64. In addition, a line perpendicular to the focal plane and passing through the center of the illumination lens 64 is defined as an optical axis of the illumination portion 16. At this time, a conjugate imaging point of the object point transferred by the light beam is referred to as a focal point.

The illumination portion 16 includes a pinhole opening 66 in the focal plane of the illumination lens 64. With such a configuration, parallel light can be emitted from the illumination portion 16. The parallel light is emitted to the surface of the object S through the beam splitter 68.

The illumination portion 16 emits parallel illumination, and the parallel illumination becomes parallel to the image-capturing optical axis C through the beam splitter 68, and reaches the object plane of the object S. Here, the beam splitter 68 may be non-polarizing or may be polarizing.

According to the present modification, it is possible to align all the directions of the light beams incident on the object points P of the object S. Therefore, as compared with a case where the directions of the light beams incident on the object points P of the object S are different, it is possible to reduce the change in the scattering angle distribution according to the directions of the incident light beams. In addition, by making the illumination light L into parallel light illumination, it is possible to make the spread of the scattering angle distribution due to minute irregularities more noticeable as compared with a case of the illumination light having a divergence angle. That is, the present first modification has an effect that the surface state of the object S can be inspected more accurately, an image reflecting the surface state of the object S can be acquired, and more detailed depth information between the image capture 22 and the object S can be acquired.

### Second Modification

The optical system 10 according to a second modification of the present embodiment will be described. Since the optical system 10 according to the present second modification is substantially the same as the optical system 10 shown in FIG. 1, the differences will be described here. The optical system 10 according to the present modification may be combined with the illumination portion 16 described in the first modification (see FIG. 8).

The shape of the light selection portion 24 is described as being a concentric circle as described in the first embodiment, but other shapes, such as a stripe shape (see FIG. 7), are also acceptable.

It is assumed that the disk-shaped first light selection region 52 on the inner side of the light selection portion 24 and the annular second light selection region 54 on the outer side of the light selection portion include polarized-light filters orthogonal to each other. The light selection portion 24 converts the light having passed through the regions 52 and 54 into, for example, light having mutually orthogonal polarized light, for example. For example, the first light beam L1 of white light (unpolarized light) incident on the object plane of the object S along the optical axis C and reflected along the optical axis C reaches the first light selection region 52 on the optical axis C. Then, the first light selection region 52 transmits a first polarized light (for example, a first polarized component of) 0° in the light selection portion 24, and does not transmit a second polarized light (for example, a second polarized component of) 90° different from the first polarized light. Therefore, the first light beam L1 is incident on the image sensor 34 as the first polarized light. The second light selection region 54 does not transmit the first polarized light (for example, the first polarized component of) 0° in the light selection portion 24, and transmits the second polarized light (for example, the second polarized component of) 90°. Therefore, the second light beam L2 is incident on the image sensor 34 as the second polarized light. Note that it is assumed that the light selection portion 24 does not have a transmission/shielding function for each wavelength as described in the first embodiment.

In addition, it is assumed that the image sensor 34 controlled by the processing apparatus 18 is a polarized-light image sensor, and can identify and receive light having polarized components orthogonal to each other (for example, the first polarized component of 0° and the second polarized component of) 90°, and acquire these polarized components as independent signals. It is assumed that the first light selection region 52 intersects with the optical axis C. According to the present embodiment, since a large amount of reflected light from minute irregularities passes through the second light selection region 54, by identifying light having passed through the second light selection region 54 based on the polarized component and acquiring an image based on the polarized light signal, it is possible to make the texture formed by the minute irregularities clear. As a result, it is possible to identify the depth more accurately by applying the DFF method.

Therefore, also in the present second modification, as described in the first embodiment, the processing apparatus 18 to be used for optical measurement includes the processor 72 that acquires, by the image capture 22, the image Ia of the object S on the optical axis C of the image capture 22 by optical imaging using the light selection portion 24 that selectively allows a plurality of wavelengths different from each other from the surface of the object S to pass through, and acquires the depth information on the object S with respect to the image capture 22 based on the variance of the pixel values of the image Ia or the variance of the pixel value change indexes. According to the present second modification, it is possible to provide the processing apparatus 18 that can acquire the depth information even for an object S having a texture or little texture.

According to the present second modification, the processing apparatus 18 (processor 72) to be used for optical measurement acquires a plurality of images by the image capture 22 while relatively moving the image capture 22 and the object S along the optical axis C of the image capture 22.

For this reason, it is possible to acquire more detailed depth information between the image capture 22 and the object S using the DFF method, DFD method, or the like.

According to the present second modification, the processing apparatus 18, the optical system 10, the optical measurement method, and the non-transitory storage medium storing the optical measurement program, which are capable of acquiring the depth information even for the object S having little texture, are provided. In addition, the processing apparatus 18, the optical system 10, the optical measurement method, and the optical measurement program can identify the three-dimensional shape of the object S by acquiring the depth information for each object point.

### Third Modification

The optical system 10 according to a third modification of the present embodiment will be described. Since the optical system 10 according to the present third modification is substantially the same as the optical system 10 shown in FIG. 1, the differences will be described here. The optical system 10 according to the present modification may be combined with the illumination portion 16 described in the first modification. In addition, the optical system 10 may be combined with the polarized-light filter as the light selection portion 24 and the polarized-light image sensor as the image sensor 34 described in the second modification.

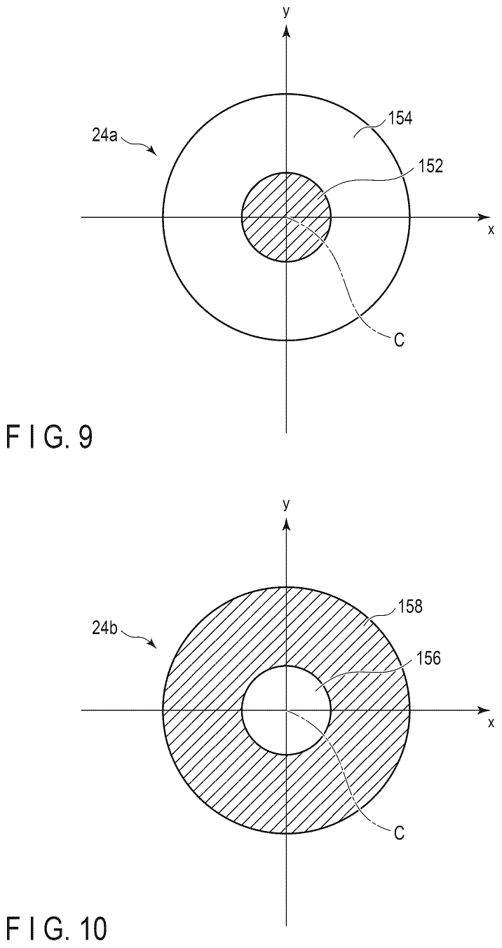

In the present third modification, it is assumed that the light selection portion 24 includes two light selection portions of a first light selection portion 24a shown in FIG. 9 and a second light selection portion 24b shown in FIG. 10, and these light selection portions can be switched and used in time series. That is, the first light selection portion 24a arranged on the focal plane f of the image-forming optical element 32 at a certain time can be switched to the second light selection portion 24b at the next moment. The first light selection portion 24a and the second light selection portion 24b may be electrically or mechanically switched.

In a case of electrical switching, the light selection portion 24 may employ a digital micromirror device (DMD), a liquid crystal panel, or the like as the light selection portions 24a and 24b.

In a case of mechanical switching, the light selection portion 24 may employ a slide mechanism in which the first light selection portion 24a shown in FIG. 9 and the second light selection portion 24b shown in FIG. 10 are arranged on a plate to slide the positions of the first light selection portion 24a and the second light selection portion 24b.

Here, it is assumed that the light selection portion 24 electrically switches between the first light selection portion 24a shown in FIG. 9 and the second light selection portion 24b shown in FIG. 10.

It is assumed that the first light selection portion 24a shown in FIG. 9 has a first light selection region 152 and a second light selection region 154. It is assumed that the first light selection region 152 intersects with the optical axis C and shields both light of the first wavelength and light of the second wavelength. The first light selection region 152 preferably shields all light (all white light). Then, it is assumed that the second light selection region 154 transmits both light of the first wavelength and light of the second wavelength. The second light selection region 154 preferably transmits all light (all white light). As a result, reflected light having the angular distribution widened by minute irregularities on the object plane of the object S can pass through the second light selection region 154. On the other hand, reflected light having a narrow angular distribution from a smooth surface on the object plane of the object S reaches the first light selection region 152 and is shielded. As a result, the processing apparatus 18 can make the texture formed by the minute irregularities clear based on light of the first wavelength and light of the second wavelength. For example, since both light of the first wavelength and light of the second wavelength are incident on the image sensor 34, the acquired image can be brighter than a case where light of one of the wavelengths is incident on the image sensor 34. That is, using light of two wavelengths instead of light of only one of the wavelengths has an effect of making the texture formed by minute irregularities clear. As a result, the processing apparatus 18 has an effect of acquiring an image reflecting the surface state of the object S and more accurately acquiring the depth information between the image capture 22 and the object S using the DFF method, the DFD method, or the like.

It is assumed that the second light selection portion 24b shown in FIG. 10 has a third light selection region (first light selection region) 156 and a fourth light selection region (second light selection region) 158. The third light selection region 156 intersects with the optical axis C. It is assumed that the third light selection region 156 transmits both light of the first wavelength and light of the second wavelength. The third light selection region 156 preferably transmits all light (all white light). Then, the fourth light selection region 158 shields both light of the first wavelength and light of the second wavelength. The fourth light selection region 158 preferably shields all light (all white light). As a result, light having the angle distribution widened by minute irregularities is shielded by the fourth light selection region 158. On the other hand, light having a narrow angular distribution from a smooth surface can pass through the third light selection region 156. As a result, the image sensor 34 can capture an image of the smooth surface with light of the first wavelength and light of the second wavelength. That is, the image sensor 34 has an effect of identifying not only the presence of the smooth surface but also characters on the smooth surface. At this time, for example, since both light of the first wavelength and light of the second wavelength are incident on the image sensor 34, the acquired image can be brighter than a case where light of one of the wavelengths is incident on the image sensor 34. In addition, if the image sensor 34 can receive light by spectrally dispersing RGB, for example, and the first wavelength is blue light, the second wavelength is red light, and the third wavelength is green light, the image sensor 34 can capture an image of the smooth surface with light of the first wavelength and the second wavelength, and further with light of the third wavelength. That is, the image sensor 34 has an effect of identifying the color of the smooth surface. Furthermore, an image captured using the second light selection portion 24b has telecentricity in a case where the image is acquired with parallel light parallel to the optical axis C. For this reason, the processing apparatus 18 can acquire a telecentric image of light having passed through the third light selection region (first light selection region) 156 among the images. Therefore, in a case where the optical system 10 acquires a plurality of images while moving the operation stage 44 by controlling the actuator 46, it has an effect that the imaging magnification of all the images does not change and the size of the object S in all the images does not change. Accordingly, using the optical system 10 according to the present third modification has an advantage of facilitating depth dimension measurement.

In the present third modification, by instantaneously switching between the first light selection portion 24a (see FIG. 9) and the second light selection portion 24b (see FIG. 10) to capture images, it is possible to simultaneously acquire a plurality of images with white light, for example, without changing the distance of the image capture 22 with respect to the object S. For this reason, the optical system 10 according to the present third modification has an effect of acquiring not only the depth information more accurately, but also the presence of a smooth surface and the color of the object S itself. Furthermore, an image captured using the second light selection portion 24b has telecentricity. Therefore, it has an effect that the imaging magnification of all the images does not change when a plurality of images is acquired while moving the operation stage 44 by the actuator 46. This has an advantage of facilitating dimension measurement.

The configuration of the optical system 10 according to the present third modification can also be described as follows. The light selection portion 24 includes the first light selection portion 24a and the second light selection portion 24b different from each other. The processor 72 can electrically or mechanically switch and use the first light selection portion 24a and the second light selection portion 24b. It is assumed that the first light selection portion 24a includes the first light selection region 152 and the second light selection region 154, and the first light selection region 152 intersects with the optical axis C. It is assumed that the second light selection portion 24b includes the third light selection region 156 and the fourth light selection region 158, and the third light selection region 156 intersects with the optical axis C. It is assumed that the third light selection region 156 transmits light passing through the second light selection region 154 and does not transmit light passing through the first light selection region 152. It is assumed that the fourth light selection region 158 transmits light passing through the first light selection region 152 and does not transmit light passing through the second light selection region 154.

By switching between the first light selection portion 24a and the second light selection portion 24b to capture an image of the object S, it is possible to simultaneously acquire a plurality of images with white light, for example, without changing the distance of the image capture 22 with respect to the object S. At this time, the optical system 10 according to the present third modification has an effect of acquiring not only depth information more accurately, but also the presence of the smooth surface and the color of the object S itself.

The processing apparatus 18 (processor 72) simultaneously acquires, as images using the image sensor 34, respective images of light having passed through the second light selection region 154 of the first light selection portion 24a and light having passed through the third light selection region (first light selection region) 156 of the second light selection portion 24b, acquires, among the images, a telecentric image with the light having passed through the third light selection region (first light selection region) 156 of the second light selection portion 24b, and calculates the depth based on the variance of the pixel values of the image based on the light having passed through the second light selection region 154 of the first light selection portion 24a.

In the present third modification, as shown in FIGS. 9 and 10, the shape of the light selection portion 24 has been described as being a concentric circle as in the first embodiment, but other shapes, such as a stripe shape (see FIG. 7), are also acceptable.

According to the present third modification, the processing apparatus 18, the optical system 10, the optical measurement method, and the non-transitory storage medium storing the optical measurement program, which are capable of acquiring the depth information even for the object S having little texture, are provided. In addition, the processing apparatus 18, the optical system 10, the optical measurement method, and the optical measurement program can identify the three-dimensional shape of the object S by acquiring the depth information for each object point.

### Second Embodiment

A scanner 14 of an optical system 10 according to a second embodiment will be described with reference to FIGS. 11 and 12.

Here, a delta-type parallel link 80 can be used together with the pedestal 42, the operation stage 44, and the actuator 46 of the scanner 14 described in the first embodiment, or instead of the pedestal 42, the operation stage 44, and the actuator 46. The parallel link 80 is an example of the scanner 14.

The delta-type parallel link 80 shown in FIGS. 11 and 12 is one of robot mechanisms that can move an appropriate light weight object. In the example shown in FIGS. 11 and 12, the parallel link 80 includes three rails 82a, 82b, and 82c along the z axis, movable portions (sliders) 84a, 84b, and 84c that move along the rails 82a, 82b, and 82c, arms 86a, 86b, and 86c having one ends supported by the movable portions 84a, 84b, and 84c, and an image capture 22 as an end effector supported by the other ends of the arms 86a, 86b, and 86c. Note that, in the image capture 22 here, it is assumed that the light selection portion 24 is incorporated between the image-forming optical element 32 and the image sensor 34 as shown in FIG. 1. Note that each of the sliders 84a, 84b, and 84c is used as an actuator such as a motor controlled by a processing apparatus 18.

The operation stage 44 is assumed to have a disk shape. The three rails 82a, 82b, and 82c are arranged at equal intervals (120° intervals) on the outer peripheral edge of the operation stage 44, for example.

By the processing apparatus 18 controlling the sliders 84a, 84b, and 84c, the sliders 84a, 84b, and 84c and the arms 86a, 86b, and 86c move independently. For this reason, the parallel link 80 can precisely control the image capture 22. In the mechanism of the parallel link 80, the position of the image capture 22 can be freely moved in an appropriate three-dimensional space by operating the three sliders 84a, 84b, and 84c. In addition, the joints between the sliders 84a, 84b, and 84c and the arms 86a, 86b, and 86c passively adjust the rotations and angles of the arms 86a, 86b, and 86c. Note that universal joints or ball joints can be used as the joints.

The delta-type parallel link 80 can be controlled with high accuracy. Since the arms 86a, 86b, and 86c move in cooperation, the position and orientation of the image capture 22 can be controlled with high accuracy.

Next, the delta-type parallel link 80 can operate at a high speed. The image capture 22 can be moved at high speed by the lightweight arms 86a, 86b, and 86c and the efficient operation mechanism.

Furthermore, the delta-type parallel link 80 has high flexibility. By combining the joints between the sliders 84a, 84b, and 84c and the one ends of the arms 86a, 86b, and 86c, the image capture 22 can be freely moved in a wide range and handle a complicated imaging scenario. In addition, the structure of the parallel link 80 evenly distributes the loads on the arms 86a, 86b, and 86c, and can operate stably.

Here, the delta-type parallel link 80 according to the present embodiment can continuously direct the optical axis C of the image capture 22 in the same direction. That is, the optical axis C of the image capture 22 moves in parallel. For this reason, the optical system 10 according to the present embodiment can capture an image when positioned directly facing the object S. With these characteristics, the image capture 22 can always capture images at a constant angle with respect to an imaging target, and can acquire highly accurate image data. By taking advantage of these characteristics, it is possible to perform highly accurate and high-speed measurement or inspection. In particular, by capturing an image when positioned directly facing the object S, the image-forming optical element 32 can form an image of an object point in the entire imaging visual field at an imaging point. On the other hand, if the image-forming optical element 32 is not positioned facing the object S, the object point in the entire imaging visual field cannot be formed at the imaging point. That is, according to the present embodiment, capturing an image of the object S with the image capture 22 positioned directly facing the object S has an advantage of always forming an image of an imaging plane orthogonal to the optical axis C over the entire imaging visual field even when any scan path is taken.

According to the present embodiment, the processing apparatus 18, the optical system 10, the optical measurement method, and the non-transitory storage medium storing the optical measurement program, which are capable of acquiring the depth information even for the object S having little texture, are provided. In addition, the processing apparatus 18, the optical system 10, the optical measurement method, and the optical measurement program can identify the three-dimensional shape of the object S by acquiring the depth information for each object point.

According to at least an embodiment described above, the processing apparatus 18, the optical system 10, the optical measurement method, and the non-transitory storage medium storing the optical measurement program, which are capable of acquiring the depth information even for the object S having little texture, are provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A processing apparatus to be used for optical measurement comprising a processor, wherein the processor is configured:
to acquire an image of an object on an optical axis of an image capture by optical imaging using a light selection portion that selectively allows a plurality of wavelengths different from each other from a surface of the object to pass through, and
to acquire depth information on the object with respect to the image capture based on variance of pixel values of the image or variance of pixel value change indexes.

2. The processing apparatus according to claim 1, wherein
the processor is configured to acquire a plurality of images by the image capture while relatively moving the image capture and the object with respect to each other along the optical axis of the image capture.

3. An optical apparatus comprising:
the processing apparatus according to claim 1;
the image capture including an image-forming optical element, and an image sensor that is controlled by the processor; and
the light selection portion, wherein
the light selection portion includes a first light selection region including the optical axis of the image-forming optical element of the image capture and a second light selection region not including the optical axis.

4. The optical apparatus according to claim 3, comprising:
a scanner that is controlled by the processor and is configured to vary a working distance between the image capture and the object, wherein
the processor is configured to acquire a plurality of images captured at two different working distances with light having passed through the second light selection region using the image sensor and the scanner, and to calculate the depth based on variance of pixel values of the images or variance of pixel value change indexes.

5. The optical apparatus according to claim 3, wherein the processor is configured:
to simultaneously acquire, as the image, images with light having passed through the first light selection region and light having passed through the second light selection region using the image sensor;
to acquire a telecentric image with the light having passed through the first light selection region among the images; and
to calculate a depth based on variance of the pixel values of the image with the light having passed through the second light selection region or variance of pixel value change indexes.

6. The optical apparatus according to claim 3, wherein
the image sensor is configured to acquire light of a first wavelength and light of a second wavelength different from the first wavelength as independent signals,
the first light selection region is configured to transmit the light of the first wavelength and is not configured to transmit the light of the second wavelength, and
the second light selection region is configured to transmit the light of the second wavelength and is not configured to transmit the light of the first wavelength.

7. The optical apparatus according to claim 3, wherein
the image sensor is configured to acquire light of a first polarized component and light of a second polarized component orthogonal to the first polarized component as independent signals,
the first light selection region is configured to transmit the light of the first polarized component and is not configured to transmit the light of the second polarized component, and
the second light selection region is configured to transmit the light of the second polarized component and is not configured to transmit the light of the first polarized component.

8. The optical apparatus according to claim 3, wherein
the light selection portion is arranged on a focal plane of the image-forming optical element.

9. The optical apparatus according to claim 3, wherein
the light selection portion includes a first light selection portion and a second light selection portion different from each other, and
the processor is configured to electrically or mechanically switch and use the first light selection portion and the second light selection portion.

10. The optical apparatus according to claim 9, wherein
the first light selection portion includes the first light selection region and the second light selection region,
the second light selection portion includes a third light selection region and a fourth light selection region,
the third light selection region intersects with the optical axis of the image capture,
the third light selection region is configured to transmit light passing through the second light selection region and is not configured to transmit light passing through the first light selection region, and
the fourth light selection region is configured to transmit light passing through the first light selection region and is not configured to transmit light passing through the second light selection region.

11. The optical apparatus according to claim 3, further comprising:
an illumination portion configured to illuminate the object with illumination light of parallel light along the optical axis of the image capture.

12. An optical measurement method comprising:
acquiring an image of an object by optical imaging using a light selection portion that selectively allows a plurality of wavelengths different from each other from a surface of the object to pass through; and
acquiring depth information on the object with respect to an image capture based on variance of pixel values of the image or variance of pixel value change indexes.

13. The optical measurement method according to claim 12, wherein
the acquiring the image of the object by the image capture includes acquiring a plurality of images while relatively moving the image capture and the object along an optical axis of the image capture.

14. A non-transitory storage medium storing an optical measurement program causing a computer to execute:
acquiring an image of an object by optical imaging using a light selection portion that selectively allows a plurality of wavelengths different from each other from a surface of the object to pass through; and
acquiring depth information on the object with respect to an image capture based on variance of pixel values of the image or variance of pixel value change indexes.

15. The non-transitory storage medium according to claim 14, wherein
the acquiring the image of the object by the image capture includes causing the computer to execute acquiring a plurality of images while relatively moving the image capture and the object along an optical axis of the image capture.
